(19) United States
(12) Patent Application Publication
(10) Pub. No.: US 2017/0222880 A1
(43) Pub. Date: Aug. 3, 2017

(54) SYSTEMS AND METHODS FOR MANAGING DATA TRANSMISSIONS BETWEEN RADIO ACCESS NETWORK NODES

(71) Applicant: Aaron CALLARD, Ottawa (CA)

(72) Inventor: Aaron CALLARD, Ottawa (CA)

(73) Assignee: Huawei Technologies Co., Ltd., Shenzhen (CN)

(21) Appl. No.: 15/012,122

(22) Filed: Feb. 1, 2016

(51) Int. Cl. H04L 12/24

(52) U.S. Cl. CPC H04L 41/12

(57) ABSTRACT

A method for managing data transmissions between Radio Access Network (RAN) nodes is disclosed. The method may be performed by a communications entity, and includes receiving a request from a recipient node that comprises a desired attribute, receiving an indication of data from a transmitting node that is suited for classifying the data into one or more data attributes, and facilitating transmission of the data from the transmitting node to the recipient node when the one or more data attributes correspond to the desired attribute.

### FIELD OF THE INVENTION

The present invention pertains to the field of network communications, and in particular to systems and methods for managing data transmissions between Radio Access Network nodes.

### BACKGROUND

Radio Access Networks (RANs) comprise a plurality of nodes utilizing Radio Access Technology (RAT) to provide connectivity between a core network and a number of User Equipment (UEs). RANs may include GSM networks with 3G, 4G and 5G network connections for mobile phones. The nodes of the RAN continually interchange and transmit data in order to serve various UEs that are associated with the nodes.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide an improved method and system for managing data transmissions between Radio Access Network nodes.

In accordance with embodiments of the present invention, there is provided a method for managing data transmissions between Radio Access Network (RAN) nodes. The method comprising: receiving, with a communications entity, a request from a recipient node, wherein the request comprises a desired attribute; receiving, with the communications entity, an indication of data from a transmitting node, the indication suited for classifying the data into one or more data attributes; and facilitating, with the communications entity, transmission of the data from the transmitting node to the recipient node when the one or more data attributes correspond to the desired attribute.

In accordance with embodiments of the present invention, there is provided a communications entity for managing data transmissions between Radio Access Network (RAN) nodes. The communications entity comprising: an input interface for receiving a request from a recipient node comprising a desired attribute, and an indication of data from a transmitting node; a processor communicatively coupled to the input interface; a memory communicatively coupled to the processor, the memory having stored thereon machine readable code which when executed by the processor classifies the data according to the indication as having one or more data attributes, and determines whether the one or more data attributes correspond to the desired attribute; and an output interface for facilitating transmission of the data from the transmitting node to the recipient node when the one or more data attributes correspond to the desired attribute.

In accordance with embodiments of the present invention, there is provided a Radio Access Network (RAN) comprising: a transmitting node; a recipient node; and a communications entity communicatively coupled to the transmitting node and the recipient node, the communications entity configured to: receive a request from the recipient node, the request comprising a desired attribute; receive an indication of data from the transmitting node; classify the data according to the indication as having one or more data attributes; determine whether any of the one or more data attributes correspond to the desired attribute, and when any of the one or more data attributes correspond to the desired attribute, facilitate transmission of the data to the recipient node.

### BRIEF DESCRIPTION OF THE FIGURES

Further features and advantages of the present invention will become apparent from the following detailed description, taken in combination with the appended drawings, in which:

FIG. 1 illustrates a Radio Access Network (RAN), according to an embodiment.

FIG. 2A illustrates a RAN including a communications entity for facilitating data transmission between nodes, according to an embodiment.

FIG. 2B illustrates a RAN including a communications entity for providing connectivity information to nodes to facilitate data transmissions, according to another embodiment.

FIG. 3 is a flow chart illustrating a method for managing data transmissions between Radio Access Network (RAN) nodes, according to an embodiment.

FIG. 4A illustrates a functional block diagram of a communications entity, according to an embodiment.

FIG. 4B illustrates a functional block diagram of a node having a communications entity instantiated therein, according to an embodiment.

FIG. 5A is a communication diagram illustrating methods for managing data transmissions between RAN nodes, according to an embodiment.

FIG. 5B is a communication diagram illustrating a method for managing data transmissions in a RAN including a router, according to an embodiment.

FIG. 6 illustrates a schematic diagram of a communications entity, according to an embodiment.

It will be noted that throughout the appended drawings, like features are identified by like reference numerals.

### DETAILED DESCRIPTION

RANs comprise a plurality of communicatively linked nodes which interchange data to provide connectivity services, for example between a core network and a number of UEs. The nodes may be physical (e.g. receivers, base stations, eNodeBs, routers, schedulers, decoders, UEs, etc.) or implemented through Network Function Virtualization (NFV) techniques so that they may be distributed and not confined to a specific physical deployment. The use of NFV allows for the creation, modification, and destruction of nodes at a greater rate to meet evolving connectivity needs or adapt to changing network conditions.

An NFV framework can be used to define a plurality of Virtual Network Functions (VNFs), each of which can correspond to a function deployed on the RAN. For example a VNF can provide the functions of a node, router, switch, gateway, firewall, load balancer, server and the like. The VNFs may also provide functions typically performed within a current Evolved NodeB (eNB), for example, scheduling, decoding, channel estimation, channel encoding, precoding of data for transmission, translation of information from one format into another format (i.e. frequency domain symbols into time domain CPRI (Common Public Radio Interface)), segmentation, reassembly of different protocols and the like. The VNFs may also provide functions or operations which are commonly attributed to layers of the eNB protocol stack. The function is virtualized in the sense that it may utilize a set of virtual resources, such as computing, storage and networking resources, rather than utilizing dedicated hardware resources. As such, VNFs may be instantiated on an as-needed basis using available virtual resources. NFV and virtual network functions architecture is described in ETSI GS NFV 001 entitled “Network Function Virtualization (NFV); Use Cases”, October 2013 and ETSI GS NFV 002 entitled “Network Function Virtualization (NFV); Architectural Framework”, October 2013, for example.

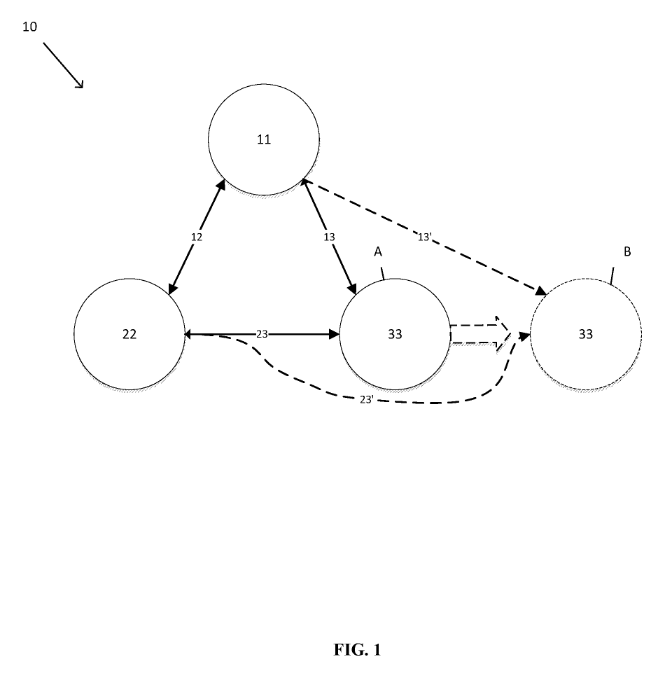

One issue that must be considered when creating or modifying nodes in an RAN is that of logistical connectivity. Referring to FIG. 1 there is shown an example of a RAN 10 comprising a first node 11, a second node 22 and a third node 33. In this example, each node has a direct peer-to-peer relationship with other nodes, and is independently responsible for making forwarding and protocol decisions in order to establish links and transmit data to another node. For example, the first node 11 must obtain or determine connectivity information for the third node 33, such as its location, transmission protocol, and routing information, in order to establish and maintain link 13 to transmit data to the third node 33. Similarly, the second node 22 must also obtain or determine connectivity information for the third node 33, in order to establish link 23 for transmitting data to third node 33. Accordingly, each node is independently responsible for handling forwarding and protocol choices for transmitting data to other nodes, and must obtain relevant connectivity information from other nodes before transmissions can be made.

Unfortunately, when an existing node moves from one location to another under this RAN configuration, it must inform all other nodes of its new location in order to maintain respective links and ensure successful communications. For example, if the third node 33 moves from location ‘A’ to location ‘B’, it must inform both the first node 11 and second node 22 of its new location so that they may update the logical connections 13, 23, to links 13′, 23′, respectively, in order to successfully transmit any data to the third node 33 at its new location “B”. Similarly, if any connectivity changes to the third node 33 are made, such as a change in transmission protocol, routing, or another connectivity parameter, it must also inform the first and second nodes 11, 22 in order update respective links to the third node 33 and ensure successful communications.

While the RAN 10 in FIG. 1 may be adequate for static or semi-static configurations where nodes are rarely created, the amount of signaling overhead required for a new node makes it difficult to scale or expand RAN 10 to meet growing network needs on a dynamic basis. For example, if a new node is created in the RAN 10 (not shown), the new node would need to provide connectivity information to each and every existing node (for example, nodes 11, 22, 33) in order to receive transmissions from those nodes. The developer of the new node must also determine and account for various interfaces and parameters of the RAN 10 and its existing nodes in order for the new node to function within the network.

Furthermore, the requirement of providing connectivity information to other nodes when an existing node is moved or modified, as commonly performed in NFV implemented RANs, can severely reduce operational efficiency of the network. For example, existing nodes must now expend computing resources to receive, process, or determine connectivity information for every new or modified node to create or maintain respective links. As more nodes are created or modified in the RAN, this cycle of continually updating multiple nodes and links results in widespread system inefficiencies and reduces desired Quality of Service (QoS) standards within the network. Accordingly, an improved system and method for managing data transmissions between RAN nodes is desired.

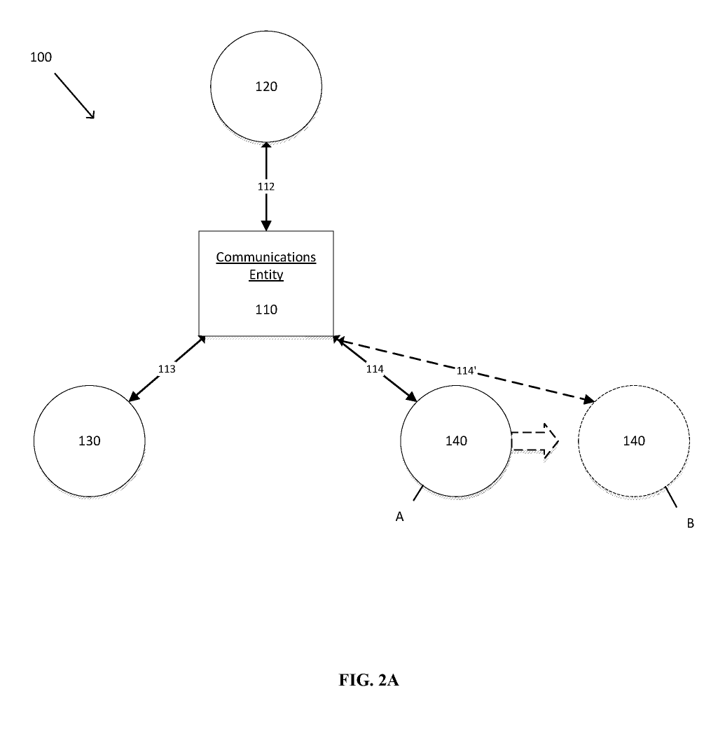

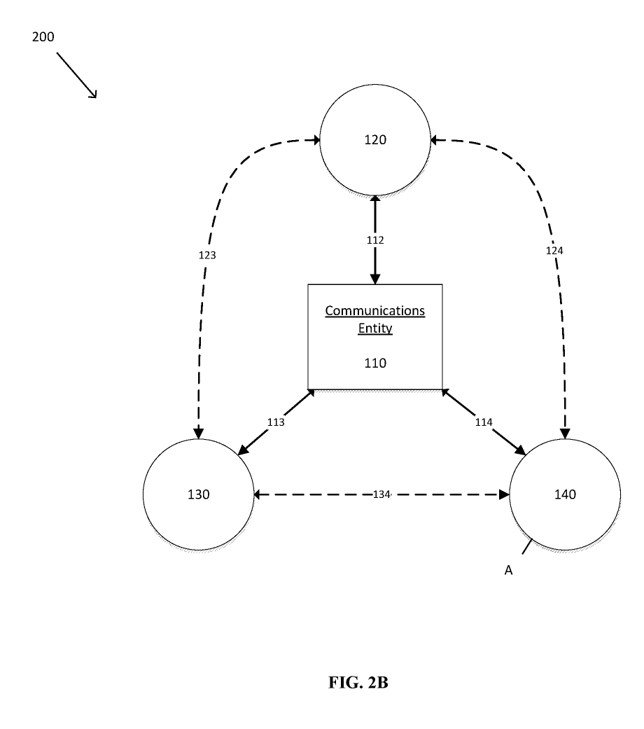

Referring to FIG. 2A, there is shown a logical system topology of a RAN 100, according to an embodiment. RAN 100 comprises a communications entity 110, and a plurality of nodes including a first node 120, a second node 130, and a third node 140. This topology of nodes may reflect the underlying system (for example a hub and spoke configuration), in which leased lines are used for communication between nodes (for which the underlying topology is unknown), or may represent the logical connections between different entities which may be introduced for reasons of scalability, which may typically be used in hierarchical network design. The nodes 120, 130, 140 may comprise transmitting nodes, recipient nodes, or both dependent on when a particular node wishes to transmit or receive data. The communications entity 110 is communicatively linked with intermediate nodes 120, 130, 140, and operatively configured to manage the dissemination of data between nodes 120, 130, 140, including the establishment, updating, and maintenance of links 112, 113, 114 to facilitate the transmission of data therebetween. As will be described in further detail below, the communications entity 110 alleviates the burden that nodes 120, 130, 140 would otherwise have to bear to establish links when a new node is created, update links when an existing node is moved or modified, and determine forwarding and protocol parameters for transmitting data to a particular node. This creates a separation of duties which reduces the amount of information nodes 120, 130, 140 must obtain from other nodes in the network, allowing each node to prioritize their independent functions.

In one embodiment, the communications entity 110 facilitates the transmission of data between nodes 120, 130, and 140 by receiving data from a transmitting node, and then subsequently forwarding the data to any recipient nodes that wish to receive the data. In operation, the communications entity 110 first receives a request from a recipient node (nodes 130 or 140, for example) for a desired attributes. The desired attribute may comprise certain types of data (e.g. scheduling information, Radio Resource Management (RRM) data, UE data, grant access data, pilot information, ID information, and so forth), or any suitable type of data categorization. Other types of desired attributes can include data relating to messages being sent over middleware, for example data relating to observed sequence or resource metrics, observed signal data, or other data as would be readily understood by a worker skilled in the art. In some embodiments, desired attributes can include data that simply corresponds to a particular transmitting node (node 120, for example). Then, if a transmitting node (node 120, for example) has data it wishes to transmit, it sends an indication of this data to the communications entity 110. The communications entity 110 may then classify the data based on the indication into one or more data attributes. For example, the data may be classified as (i.e. correspond to data attributes) scheduling information, RRM data, UE data, ID information, or according to any other potential attribute described above. Classification is performed in order to determine and match the recipient nodes that would want the data based on their desired attribute(s). The communications entity 110 then facilitates transmission of the data from the transmitting node (node 120) to the recipient nodes (nodes 130, 140) when the one or more data attributes correspond to the desired attribute requested by the recipient node. This may include for example, the communications entity 110 receiving the data from the transmitting node (node 120), and subsequently forwarding the data to the appropriate recipient node (130, or 140) via respective links (113, 114). In this way, the communications entity 110 manages forwarding and protocol decisions for each node (120, 130, 140), and alleviates the responsibility those nodes would otherwise have to manage and maintain links for transmitting and receiving data.

As indicated above, the communications entity 110 can also maintain logistical information (including links) when an existing node moves from one location to another location (in a network topology), and/or reconfigure links when a node changes to a new transmission protocol or configuration. Still referring to FIG. 2A for example, if node 140 moves from location ‘A’ to location ‘B’, communications entity 110 may determine or be notified of this move and proceed to modify link 114 to link 114′ to maintain communications with node 140 at location ‘B’. In this way, node 140 does not need to inform every other node in RAN 100 with which it communicates, of its new location ‘B’, and nodes 120, 130 need not expend computing or communication resources to update respective links pointing at location ‘A’ to location ‘B’. Subsequent data received from a transmitting node (node 120, for example) intended for node 140, would be sent using updated link 114′ to ensure successful data delivery. The communications entity 110 can also manage changes in transmission protocol and other parameters to maintain connectivity between nodes 120, 130, 140 under changing conditions or configurations of RAN 100.

In some embodiments, the indication sent by the transmitting node (node 120, for example) to the communications entity 110 includes the data itself that the transmitting node wishes to transmit. The communications entity 110 may then store the data in memory, and proceed to classify the data into one or more data attributes. Once the communications entity 110 determines the recipient nodes that would want the data based on their desired attributes, the communications entity 110 can forward the data from the memory to the appropriate recipient nodes. The memory may be internal to the communications entity 110, or deployed throughout different physical platforms.

In some embodiments where the indication includes the data that the transmitting node wishes to transmit, the one or more data attributes may be identified from the headers of the data. In this way, the communications entity 110 can easily identify and classify the data into corresponding data attributes.

In some embodiments, the headers of the data which the transmitting node transmits, indicates the data attributes of the data. In this way, any entity that receives the data may easily classify it from the headers. For example, one or more data attributes can be the raw information corresponding to the data, such as the originating UE ID. In some cases, the data attributes can be a bit field which has been assigned to be attached to the header of the data by the communication entity 110. For example, a transmitting node may send an indication that certain data may be generated, and the communication entity 110 responds with connectivity information including the desired method for transmitting this data. The desired method can be indicative of the header(s) that are to be attached to the data. Accordingly, when the transmitting node has this information to be sent, it can attach it to the respective header of the data. The communication entity 110 can subsequently route the data with that particular header to the desired destinations or recipient nodes.

In some embodiments, the communications entity 110 may demand an indication from a transmitting node, or request data corresponding to one or more desired attributes from one or more transmitting nodes (for example, the communications entity 110 may demand data from a certain UE, or scheduling information from the transmitting node). In some embodiments, the demand from the communications entity 110 may be prompted in response to a request from a recipient node for data corresponding to the desired attribute(s) (for example, the recipient node may make a request for data from a certain UE, or scheduling information from the same transmitting node). The communications entity 110 can then in response, make a demand to one or more transmitting nodes for data having this attribute (for example, scheduling information for a particular UE associated with the transmitting nodes). The transmitting node(s) in response, can provide the relevant data (if any) to the communications entity 110, which in turn, provides it to the appropriate recipient node. This communication can be done either before or after the specific data/information becomes available. In some embodiments, the scheduling information for a UE can represent a request that any time a particular user is scheduled the scheduling information (for example the grant) can be forwarded to the communications entity 110.

In some embodiments, the communications entity 110 can additionally filter the data received from the transmitting node using a number of filtering methods and/or based on predetermined criteria. For example, the filtering methods may include topic based filtering, content based filtering, type based filtering, or other filtering methods as would be readily understood by a worker skilled in the art or a combination thereof. When using topic based filtering for example, the data may comprise a number of parameters (e.g. UE ids, resource blocks, Tx points, transmission power) from a particular node; if the predetermined criteria is a particular UE, the communications entity 110 may accordingly filter out any data which does not relate to that particular UE from the particular node. For example, topics can typically be grouped hierarchically thereby allowing for efficient implementation of filters. When using content based filtering for example, the data may be filtered based on the semantics of the data; the predetermined criteria may comprise a particular string, and the communications entity 110 may choose to forward the data based on identification of the string in the data. When using type based filtering for example, the filters may comprise executable code that is sent on the data. The communications entity 110 can implement any or all of these methods to filter data based on any number of relevant criteria, including resource blocks, user Ids, and so forth.

In some embodiments, the filtering performed by the communications entity 110 can be based on parameters reflective of data ID, remote radio head (RRH) ID, logical channel identifiers, scheduling dependent information or other parameter or combination of parameters as would be readily understood by a worker skilled in the art. For example, parameters reflective of data ID can be indicative of a user identifier for which a flow of data occurs. Examples thereof can be a radio network temporary identifier (RNTI), an internet protocol (IP) address, port number, a radio bearer identifier, a service identifier (i.e. a data flow over which the data from multiple users flows), a service function chain identifier and the like. In addition, parameters reflective of RRH ID can refer to a label indicative of where the data is going (i.e. the downlink (DL)) or where the data is coming from (i.e. the uplink (UL). In some embodiments, RRH ID may correspond one-to-one with physical antennas, or virtual antennas, which may be combinations of multiple physical antennas). The RRH ID may also refer to one or more particular transmission parameters, which may include demodulation reference signal (DMRS) IDs. Furthermore, parameters reflective of logical channel identifiers can include information related to specific subspaces of signals. For example, logical channel identifier can refer to specific time/frequency resources (i.e. resource blocks (RB) in LTE). In some embodiments, logical channel identifiers can be reflective of other media access control (MAC) schemes, code in code division multiple access (CDMA), sequence in subcarrier multiple access (SCMA) or other. In addition, parameters reflective of scheduling dependent information can be indicative of filters which correspond to conditional statements, for example signals which generate interference above X at RRH Y.

In some embodiments, the filtering performed by the communications entity 110 may act upon data which is not explicitly available in a packet header (e.g. separate from the data header). For instance a data flow, may relate to a radio bearer, which has implicit information of the user or antenna to which it maps, thus filters targeting UE ID may correspond to packets containing particular radio bearers. According to embodiments, the communication entity 110 is configured to ensure that appropriate steps are taken.

In some embodiments, the communications entity 110 may further setup forwarding rules to directly facilitate data transmissions between RAN nodes. For example, the forwarding rule can be based on the requests received by the recipient nodes, to directly, or indirectly forward data from a transmitting node to one or more recipient nodes, through any applicable intermediary/intervening nodes.

In some embodiments, the communication entity 110 may configure intermediary nodes (not shown) to forward matching data via appropriate links to indented destination(s). This may be done with forwarding tables in a Software Defined Networking (SDN) network, using matching fields in the data packets. Referring to FIG. 2 for example, an OpenFlow router (not shown) physically connecting communication entity 110 to node 130 (i.e. over which link 113) may have a forwarding table configured to forward any data with a matching bitfield to node 140. Node 130 may prepend the filtering data (i.e. UE id) to the transmitted information. This bitfield, which may be part of a header, would be of a known offset from the beginning of the packet, and thus may be used for packet forwarding by most SDN routers (i.e. routers which support some form of SDN). This allows the rerouting of data streams to be modified, while only informing the intermediary nodes (for example, nodes which are not access nodes or base stations or eNBs). This rerouting of data streams may be further enhanced by grouping similar information and packetizing information along these headers. Put another way, this rerouting may be described as forbidding the amalgamation of nodes with dissimilar information classification, such as headers.

While FIG. 2A illustrates the communications entity 110 in a logically centralized location between nodes 120, 130, 140, in other embodiments (not shown) communications entity 110 may be deployed in a distributed manner shared with various libraries in a defined interface. The communications entity 110 may be instantiated as a functional entity deployed on a single platform, or across multiple platforms, according to various embodiments.

FIG. 2B illustrates another embodiment of a RAN 200, in which the communications entity 110 facilitates the transmission of data between nodes 120, 130, and 140 through the provision of connectivity information to transmitting nodes; the transmitting nodes can then directly transmit data to one or more recipient nodes using the connectivity information, for example, to establish direct links 123, 124, 134. As the communications entity 110 maintains updated connectivity information relating to nodes 120, 130, and 140, including their (logical) location, routing, and transmission protocol parameters, the connectivity information provided to the transmitting node will reflect any recent changes to ensure successful data transmissions to appropriate recipient nodes.

In operation, the communications entity 110 first receives a request from a recipient node (node 130 or 140, for example) for a desired attribute. A transmitting node (node 120, for example) then sends an indication of data to the communications entity 110 when it has data it wishes to transmit. The communications entity 110 may then classify the data based on the indication into one or more data attributes; this is to determine which recipient nodes (nodes 130 and 140, for example) would want the data based on their desired attributes. The communications entity 110 then sends connectivity information back to the transmitting node (node 120) including that of recipient nodes that want the data, which may include their location/path information, and additionally include one or more protocols which should be implemented. The transmitting node (node 120) now having connectivity information for recipient nodes which want the data (nodes 130, 140, for example), can establish direct links (123, 124) to directly transmit the data to the appropriate recipient nodes (130, 140). In this way, the transmitting nodes of RAN 200 are able to directly transmit data to appropriate recipient nodes, without having to maintain connectivity information or manage forwarding or protocol decisions for all other nodes under dynamically changing circumstances. The communications entity 110 manages connectivity, forwarding, and protocol information and decisions on behalf of nodes 120, 130, 140, and provides updated connectivity information as required, in order to establish links 123, 124, 134 to enable direct transmission between nodes.

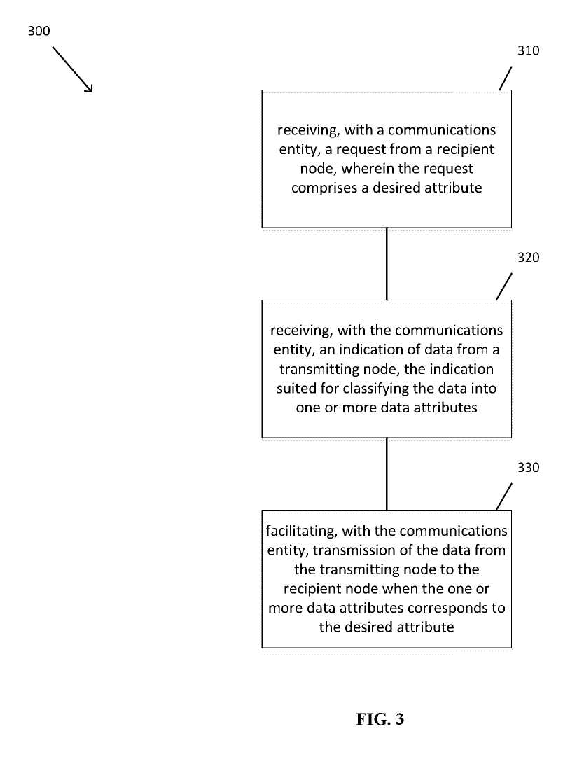

Referring to FIG. 3, there is shown a flow chart illustrating a method 300 for method for managing data transmissions between Radio Access Network (RAN) nodes, according to an embodiment. The method 300, may be performed communications entity 110 in RAN 100 of FIG. 2A, or RAN 200 of FIG. 2B, for example. At step 310, the communications entity 110 receives a request from a recipient node, wherein the request comprises a desired attribute for data. At step 320, the communications entity 110 receives an indication of data from a transmitting node, wherein the indication is suited for classifying the data into one or more data attributes. For example, the indication may comprise headers which list corresponding data attributes of the data, or may comprise the data itself from which the communications entity 110 may perform classification of the data. At step 330, the communications entity 110 facilitates transmission of the data from the transmitting node to the recipient node when the one or more data attributes corresponds to the desired attribute. For example, when the one or more data attributes matches the desired attribute, the communications entity 100 may receive the data from the transmitting node and forward it to the recipient node, or the communications entity 110 may provide connectivity information to the transmitting node, which in turn, establishes appropriate links to directly transmit the data to the recipient node.

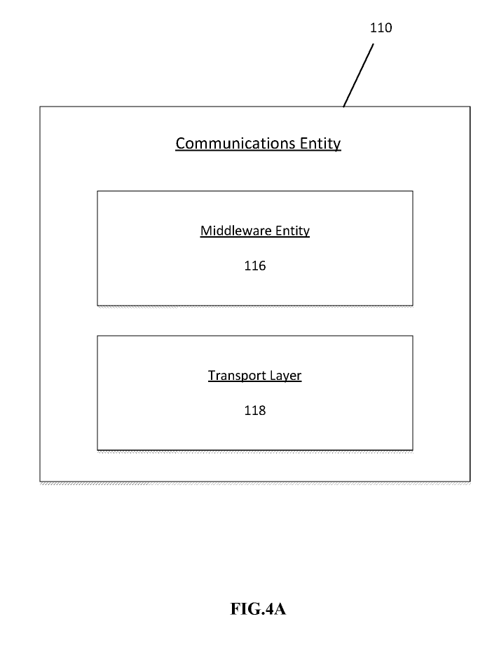

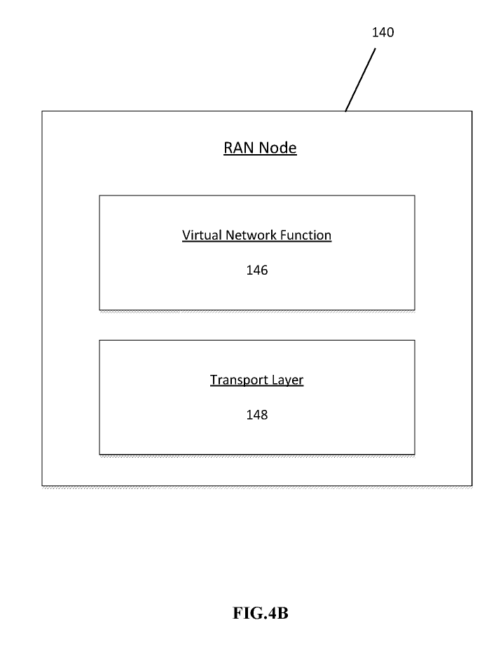

Referring to FIG. 4A, there is shown a functional block diagram of the communications entity 110, according to an embodiment. The communications entity comprises a middleware entity 116, and a transport layer 118. The middleware entity 116 is operationally configured to make forwarding and protocol choices, which can be provided to transmitting nodes for transmitting data to appropriate recipient nodes. The middleware entity 116 supports the sending and receiving of data between distributed systems (not shown), and allows for application modules to be distributed over heterogeneous platforms. For example, middleware entity 116 may provide software elements within the RAN that support asynchronous calls between a client and a server. Additionally, middleware entity 116 can reduce involvement of application developers that may span multiple operating systems and network protocols, for example, in complex master-slave client/server mechanisms. The communications entity 116 may be implemented with advanced queuing protocol, data distribution service, or extensible presence protocol, in certain embodiments. The transport layer 118 is a distributed communications layer that insulates application developers from details of various operating systems and network interfaces. For example, application programming interfaces (APIs) that extend across diverse platforms and networks.

Referring to FIG. 4B, there is shown a functional block diagram of a communication entity which is instantiated jointly within node 140, in accordance with an embodiment of the present invention. The communications entity comprises a traditional virtual network function (VNF) 146, and a transport layer 148. The VNF 146 performs operations generating and consuming relevant information. This information passes to the transport layer 148 irrespective of whether this information needed. The transport layer 148 entity supports the sending and receiving of data between distributed systems (not shown), and allows for application modules to be distributed over heterogeneous platforms. For example, transport layer 148 may exchange information between different entities, allowing asynchronous calls between a client and a server (not shown). Additionally, transport layer 148 can reduce involvement of application developers that may span multiple operating systems and network protocols, for example, in complex master-slave client/server mechanisms. In some embodiments, the transport layer 148 may be implemented with an advanced queuing protocol, data distribution service, extensible presence protocol, or a remote function call protocol or the like. In addition, the transport entity may implement network aware protocols, which in some instances may be proprietary protocols. The transport layer 148 is a distributed communications layer that insulates application developers from details of various operating systems and network interfaces. This transport layer may be interacted with directly through software API calls, through a second transport protocol (TCP/IP, UDP/IP or others), or through a combination.

In some embodiments, the functionality of the transport layer 148 may be instantiated as a separate VNF, or may be provided as executable code which is executed by VNF 146, or installed as a ‘driver’ for the ports of the virtual machine (VM) or other techniques for interacting with external function calls as would be readily understood by a worker skilled in the art.

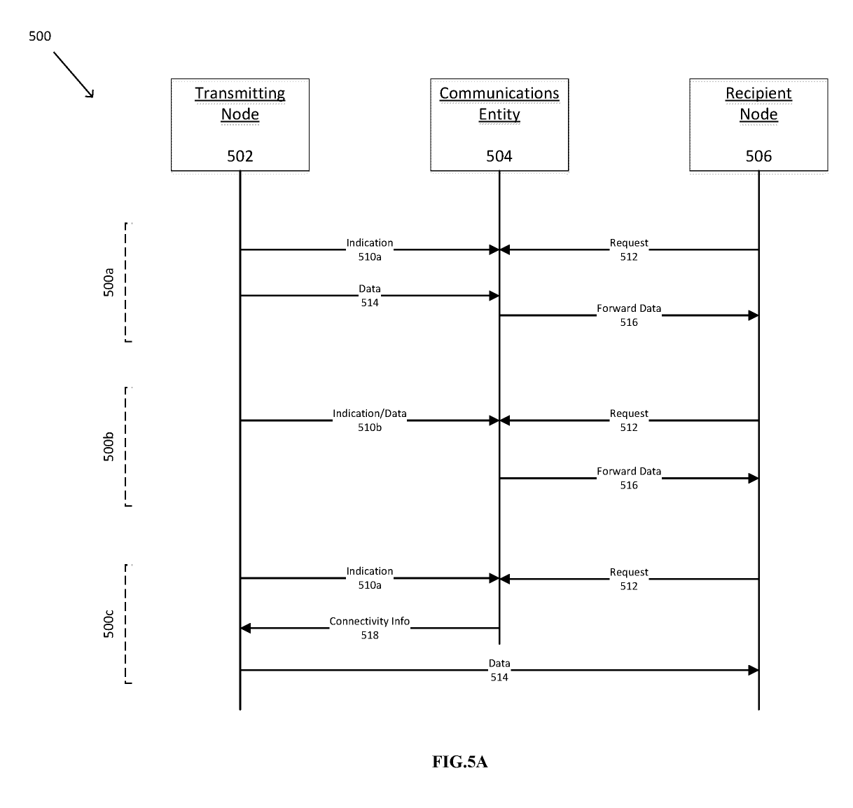

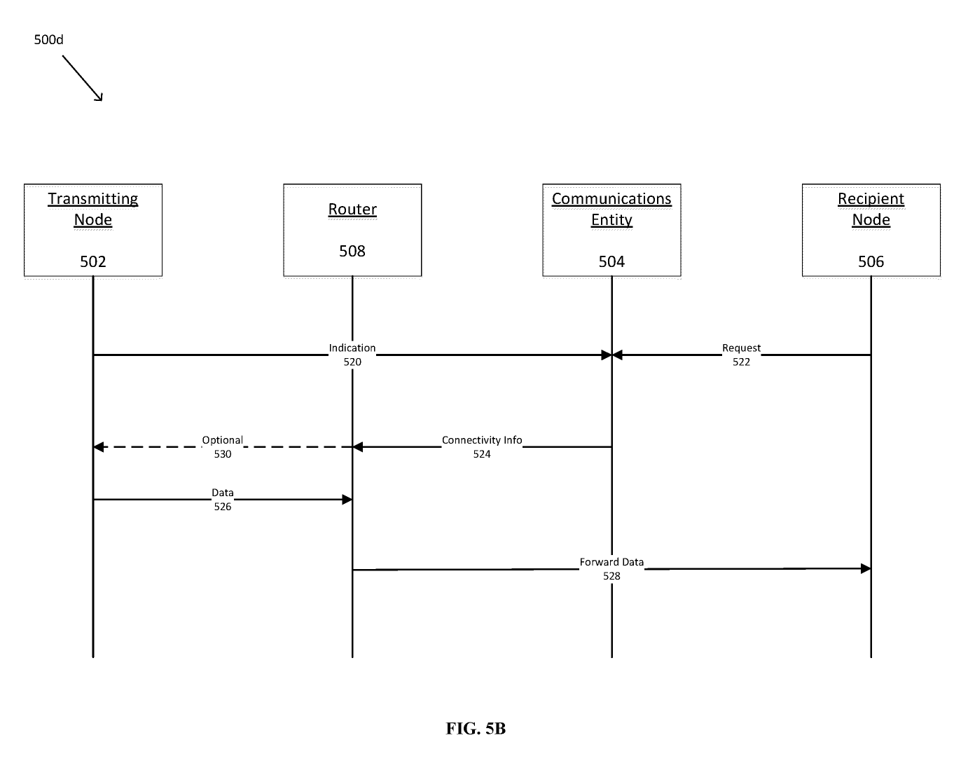

Referring to FIG. 5A, there is shown a communication diagram 500 illustrating various embodiments of methods for managing data transmissions between RAN nodes with a communications entity 504.

In the first example 500a, the communications entity 504 receives a request 512 from a recipient node 506, for data having a desired attribute. An indication 510a of data is also received from a transmitting node 502, which may be used for classifying data which the transmitting node 502 wishes to send, into one or more data attributes. If the one or more data attributes corresponds to the desired attribute, the communications entity 504 facilitates data transmission from the transmitting node 502 to the recipient node 506. As shown in 500a, the facilitating of data transmissions is performed by receiving data 514 from the transmitting node 502, and forwarding data 516 to the recipient node 506. In some embodiments, the data 514 may be previously received by the communications entity 504 and classified into one or more data attributes, but would not be forwarded to recipient node 506 until the request 512 for data corresponding to the desired attribute is received by the communications entity 504.

In the second example 500b, the communications entity 504 receives a request 512 from a recipient node 506, for data having a desired attribute. An indication 510b including the data which the transmitting node 502 wishes to transmit, is also sent to the communications entity 504. If the data corresponds to the desired attribute, the communications entity 504 facilitates data transmission from the transmitting node 502 to the recipient node 506, by forwarding data 516 to the recipient node 506.

In the third example 500c, the communications entity 504 receives a request 512 from a recipient node 506, for data having a desired attribute. An indication 510a of the data which the transmitting node 502 wishes to transmit is also sent to the communications entity 504. If the data corresponds to the desired attribute, the communications entity 504 facilitates data transmission from the transmitting node 502 to the recipient node 506. As shown in 500c, this is performed by the communications entity 504 providing connectivity information 518 to the transmitting node, including information of recipient nodes which want the data based on the indication 510a. The transmitting node 502 in response can directly send data 514 to the recipient node 506 using the connectivity information 518 provided by the communications entity 504.

Referring to FIG. 5B, there is shown a communication diagram illustrating a method for managing data transmissions between RAN nodes, according to an embodiment. The communications entity 504 receives a request 522 from a recipient node 506 for data corresponding to a desired attribute. An indication 520 of data is received from a transmitting node 502 of the data which it wishes to transmit. The data is then classified according to the indication 520 into one or more data attributes by the communications entity 504. If the one or more data attributes correspond to the desired attribute, the communications entity 504 facilitates transmission of the data from the transmitting node 502 to the recipient node 506. As shown in FIG. 5B, this is performed by providing connectivity information 524 to router 508 enabling the routing of the data 526 from the transmitting node 502 to the router 508, which forwards data 528 to the recipient node 506. In some embodiments, the connectivity information is transmitted to the transmitting node 502 (indicated as optional 530), wherein the transmitting node 502 can then associate appropriate details with the data (for example in the header of the data packets) enabling the router 508 to appropriately forward the data to the recipient node 506.

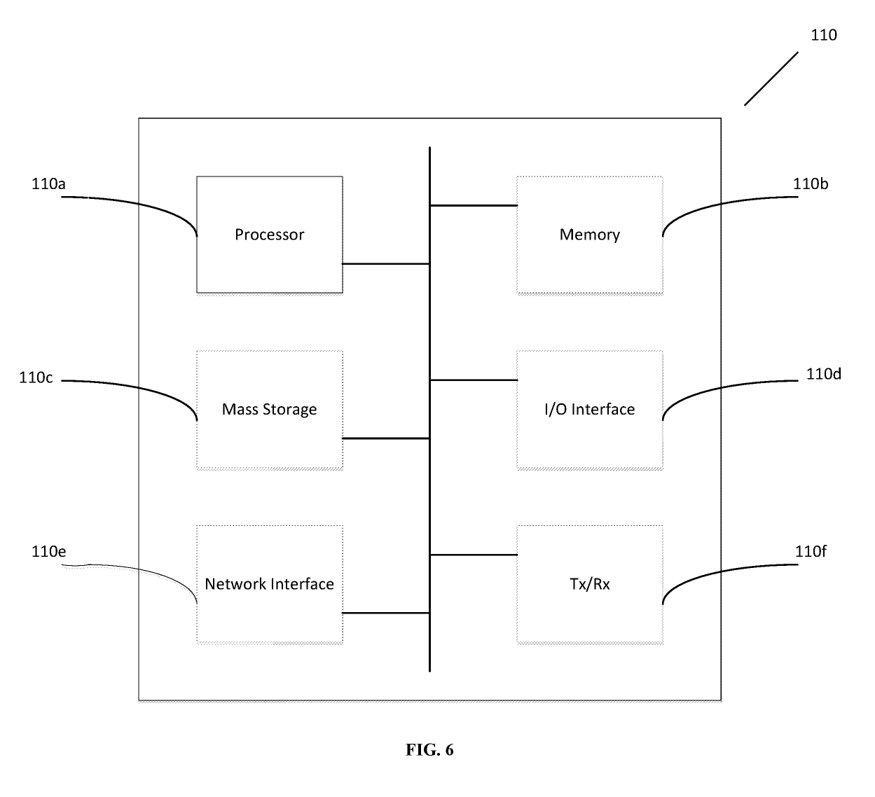

Referring to FIG. 6, there is shown a schematic diagram of a hardware module comprising a communications entity 110 deployed thereon, according to an embodiment. In other embodiments (not shown), other functional components may be similarly deployed on the hardware module. As shown, the communications entity 110 includes a processor 110a, memory 110b, non-transitory mass storage 110c, I/O interface 110d, network interface 110e, and a transceiver 100f, all of which are communicatively coupled via bi-directional bus. According to certain embodiments, any or all of the depicted elements may be utilized, or only a subset of the elements. Further, communications entity 110 may contain multiple instances of certain elements, such as multiple processors, memories, or transceivers. Also, elements of communications entity 110 may be directly coupled to other elements without the bi-directional bus.

The I/O interface 110d, and/or transceiver 110f may be implemented to receive requests from recipient nodes, receive indications and/or data from transmitting nodes, and transmit data to recipient nodes, according to different RAN configurations having wired or wireless links between nodes. The network interface 110e may be used to communicate with other devices or networks (not shown) in determining forwarding, protocol, and other data delivery decisions to facilitate data transmission between nodes.

The memory 110b may include any type of non-transitory memory such as static random access memory (SRAM), dynamic random access memory (DRAM), synchronous DRAM (SDRAM), read-only memory (ROM), any combination of such, or the like. The mass storage element 110c may include any type of non-transitory storage device, such as a solid state drive, hard disk drive, a magnetic disk drive, an optical disk drive, USB drive, or any computer program product configured to store data and machine executable program code. According to certain embodiments, the memory 110b or mass storage 110c may have recorded thereon statements and instructions executable by the processor 110a for performing the aforementioned functions and steps of the communications entity 110.

Embodiments of the present invention are directed towards systems and methods for managing data transmissions between RAN nodes with a communications entity 110, 504. The communications entity 110, 504 maintains updated connectivity information for the RAN nodes to facilitate data transmission from a transmitting node to one or more recipient nodes. For example, if a certain RAN node moves to a new location, or changes to a different communications protocol/configuration, it may simply update the communications entity 110, 504 instead of informing all other nodes in the RAN; the communications entity 110, 504 can then facilitate desired data transmissions to the updated location. Accordingly, for a RAN comprising n nodes, the number of logical links between nodes is reduced from n*n to n links, and the number of nodes/entities that need to be informed upon a location change is reduced from n to one (1). This may drastically reduce the overhead signalling and processing needed upon system and configurational changes in the RAN, thereby allowing each node to focus on its individual functions

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the scope of the invention. The specification and drawings are, accordingly, to be regarded simply as an illustration of the invention as defined by the appended claims, and are contemplated to cover any and all modifications, variations, combinations or equivalents that fall within the scope of the present invention. The scope of the claims should not be limited by the embodiments set forth in the examples, but should be given the broadest interpretation consistent with the description as a whole.

1. A method for managing data transmissions between Radio Access Network (RAN) nodes comprising:
receiving, by a communications entity within a Radio Access Network (RAN), a request from a recipient node within the RAN, wherein the request comprises a desired attribute;
receiving, by the communications entity, an indication of data from a transmitting node within the RAN, the indication suited for classifying the data into one or more data attributes; and
upon determining that the desired attribute corresponds to the one or more data attributes, facilitating, by the communications entity, transmission of the data from the transmitting node to the recipient node.

2. (canceled)

3. The method of claim 1 further comprising maintaining logistical information of the recipient node when it moves to a new location, wherein the step of facilitating comprises transmitting the data from the transmitting node to the recipient node at the new location.

4. The method of claim 1 further comprising collecting transmission protocol information of the recipient node when it changes to a new transmission protocol, wherein the step of facilitating comprises transmitting the data from the transmitting node to the recipient node using the new transmission protocol.

5. The method of claim 1 wherein the indication comprises the data.

6. The method of claim 1 wherein the step of facilitating comprises receiving the data from the transmitting node, and forwarding the data to the recipient node.

7. The method of claim 6 further comprising filtering the received data according to a predetermined criteria, wherein forwarding the data comprises forwarding the filtered data to the recipient node.

8. The method of claim 1 wherein the step of facilitating comprises providing connectivity information to the transmitting node for directly transmitting the data to the recipient node.

9. The method of claim 1 wherein the step of facilitating comprises updating one of more forwarding tables of intermediary RAN nodes, and forwarding the data from the transmitting node to the recipient node via the intermediary RAN nodes.

10. The method of claim 1 wherein the desired attribute corresponds to a particular transmitting node or particular data type.

11. The method of claim 1 further comprising determining a transmission protocol for transmitting the data to the recipient node, wherein the step of facilitating comprises transmitting data to the recipient node using the determined transmission protocol.

12. The method of claim 1 further comprising determining a routing for transmitting the data to the recipient node, wherein the step of facilitating comprises transmitting the data according to the determined routing.

13. The method of claim 1 further comprising updating connectivity information for the recipient node, wherein the step of facilitating comprises transmitting the data from the transmitting node to the recipient node according to the updated connectivity information.

14. A communications entity for managing data transmissions between Radio Access Network (RAN) nodes, the communications entity comprising:
an input interface for receiving a request from a recipient node within a Radio Access Network (RAN), the request comprising a desired attribute, and the input interface further for receiving an indication of data from a transmitting node within the RAN;
a processor communicatively coupled to the input interface;
a memory communicatively coupled to the processor, the memory having stored thereon machine readable code which when executed by the processor classifies the data according to the indication as having one or more data attributes, and determines whether the one or more data attributes correspond to the desired attribute; and
an output interface for facilitating transmission of the data from the transmitting node to the recipient node upon determining that the one or more data attributes correspond to the desired attribute.

15. The communications entity of claim 14 wherein input interface is configured to receive the data from the transmitting node, and the output interface is configured to forward the data to the recipient node when the one or more data attributes correspond to the desired attribute.

16. The communications entity of claim 14 wherein the output interface is configured to transmit connectivity information to the transmitting node for directly transmitting the data to the recipient node when the one or more data attributes correspond to the desired attribute.

17. The communications entity of claim 14 further configured to update one or more forwarding tables of intermediary RAN nodes.

18. The communications entity of claim 14 wherein the desired attribute corresponds to a particular transmitting node or a particular data type.

19. The communications entity of claim 14 further configured to determine a transmission protocol or a routing for transmitting the data to the recipient node.

20. The communications entity of claim 14 further configured to filter the data according to predetermined criteria.

21. A Radio Access Network (RAN) comprising:
a transmitting node;
a recipient node; and
a communications entity communicatively coupled to the transmitting node and the recipient node, the communications entity configured to:
receive a request from the recipient node, the request comprising a desired attribute;
receive an indication of data from the transmitting node;
classify the data according to the indication as having one or more data attributes;
determine whether any of the one or more data attributes correspond to the desired attribute, and when any of the one or more data attributes correspond to the desired attribute, and
upon determining that the desired attribute corresponds to the one or more data attributes facilitate transmission of the data to the recipient node.
